(19) United States
(12) Patent Application Publication
(10) Pub. No.: US 2009/0164970 A1
(43) Pub. Date: Jun. 25, 2009

(54) System for Managing Automated Report Versions

(75) Inventors: Adam Gentry, Livermore, CA (US); Joshua Steven Borges, Brentwood, CA (US); Sean Meyers, San Ramon, CA (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 11/961,633

(22) Filed: Dec. 20, 2007

(51) Int. Cl. G06F 9/44

(52) U.S. Cl. 717/101

(57) ABSTRACT

Disclosed systems manage the modification of objects such as automated reports. Access to modified versions of an automated report is controlled during the modification life cycle. A developer checks out a copy of an automated report and stores minor versions of the automated report during modification. A major version of the automated report is backed up and a copy of the modified automated report is transported to a quality control agent, which may be given substantially exclusive access to the modified automated report. Upon the quality control agent indicating the automated report is a quality-compliant automated report, the quality-compliant automated report is transported to a release manager. The release manager is for determining whether the quality-compliant automated report is a releasable automated report. Upon the release manager determining the quality-compliant automated report is a releasable automated report, the releasable automated report is released to production and replaces the original automated report.

### BACKGROUND

1. Field of the Disclosure

The present disclosure generally relates to software change management and more particularly to systems and methods for managing versions of automated reports.

2. Description of the Related Art

Software change management (also known as, software configuration management) relates to methods and systems for modifying software objects such as automated reports. During the development life cycle of a software object, an administrator may be responsible for manually directing the flow of the software object as modifications are performed and checked for quality compliance. In some systems, it may be necessary for an administrator to open a software object with specialized development software to transport the software object between personnel, for example between developers and quality control agents.

### BRIEF DESCRIPTION OF THE DRAWINGS

FIG. 1 illustrates an enterprise environment implementing disclosed embodiments;

FIG. 2A and FIG. 2B illustrate a methodology for managing development of and access to automated report versions in accordance with disclosed embodiments; and

FIG. 3 illustrates a data processing system for use with disclosed embodiments.

### DESCRIPTION OF THE EMBODIMENT(S)

In one aspect, a method is disclosed for controlling access to report versions. The method includes receiving a production report related to a request for revision. The method further comprises checking out the production report to a developer for adapting the production report according to the request for revision. Following adaptation by the developer, the method includes checking in the modified production report. In addition, the method includes transporting the modified production report to a quality control agent for a determination of whether the modified production report is a quality-compliant production report. If the modified production report is a quality-compliant production report, the method involves transporting the quality-compliant production report to a release manager for determining whether the quality-compliant production report is a releasable production report. If the quality-compliant production report is a releasable production report, the method includes transporting the releasable production report to production. In some embodiments, if the modified production report is not a quality-compliant production report, the method includes determining whether the modified production report should undergo further modification. If the modified production report should undergo further modification, the method includes checking out the modified production report to the developer for further processing. In some embodiments, if the modified production report should not undergo further modification, the method includes abandoning the modified production report.

In another aspect, a computer program stored on a computer readable medium is disclosed. The computer program has instructions operable for storing a production report related to a request for revision. Further instructions are operable for providing substantially exclusive access to the production report to a developer for adaptation to a modified production report. In addition, the computer program has instructions operable for storing the modified production report following adaptation by the developer and providing substantially exclusive access to the modified production report to a quality control agent. Providing substantially exclusive access to the modified production report to a quality control agent is for a determination of whether the modified production report is a quality-compliant production report. If the modified production report is a quality-compliant production report, further instructions are operable for providing substantially exclusive access to the quality-compliant production report to a release manager for determining whether the quality-compliant production report is a releasable production report. If the quality compliant production report is a releasable production report, further instructions are operable for substituting the production report with a releasable production report. In some embodiments, if the modified production report is not a quality-compliant production report, further instructions are operable for determining whether the modified production report requires further modification. If the modified production report requires further modification, further instructions are operable for providing to the developer substantially exclusive access to the modified production report for further processing. In other embodiments, if the modified production report does not require further modification, further instructions are operable for abandoning the modified production report by restricting access to the modified production report.

An additional aspect of the disclosure relates to a software change management server with a machine-readable medium having instructions operable for copying an automated report. The copied automated report is for modification by a developer. Further instructions are operable for checking out the automated report to the developer and storing one or more minor versions of the automated report. Instructions are included for checking in a revised version of the automated report in response to a check-in request by the developer and creating a major version of the automated report based on the revised version. In response to a transport request by the developer, further instructions operate to copy the major version of the automated report as a modified automated report and transport the modified automated report to a quality control agent. The quality control agent is for determining whether the modified automated report is a quality-compliant report. Accordingly, in response to transport, the quality control agent has substantially exclusive access to the modified automated report. In response to the quality control agent indicating the modified automated report is a quality-compliant report, further instructions are operable for copying the modified automated report as a quality-compliant automated report and transporting the quality-compliant automated report to a release manager. The release manager is for determining whether the quality compliant report is a releasable automated report. Accordingly, in response to transport, the release manager has substantially exclusive access to the quality-compliant automated report. In response to the release manager indicating the quality-compliant report is a releasable report, further instructions are operable for backing up a copy of the quality-compliant automated report and replacing the quality-compliant automated report with the releasable report.

In the following description, for the purposes of explanation, numerous specific details are set forth in order to provide a thorough understanding of the disclosed embodiments. A person of ordinary skill in the art should recognize that embodiments might be practiced without some of these specific details. In other instances, well-known structures and devices may be shown in block diagram form or omitted for clarity.

Disclosed embodiments relate to the creation, storage, tracking, removal and migration of automated reports. In some embodiments, automated reports exist in software stored on computer readable media and include instructions operable to assist an enterprise (e.g., a business) with query and analysis of the enterprise's internal processes. For example, automated reports may relate to payroll, fraud, accounts receivable, accounts payable, revenue, assets, liabilities, and expenditures. A company that offers software-based systems for utilizing automated reports operates under the trademark “Business Objects.” Illustrative software-based systems from Business Objects that relate to automated reports include those offered under the trademarks Crystal Reports, Crystal Enterprise, Business Objects Enterprise XI, Crystal Xcelsius, and Web Intelligence. Other automated reports may be produced using word processing software, for example a software-based product offered in various versions under the trademark Microsoft Office or the trademark Microsoft Word. In summary, embodiments of the present disclosure relate to software change management systems that may be used to identify automated reports that need modification (or creation), backup copies of the automated reports during modification, provide access to the appropriate personnel for modification, manage versions of the automated reports during modifications, test the modifications, and manage the quality control and release of the automated report to production.

Disclosed embodiments provide developers a structured system to check-in, check-out, test and create new documents. Developers may be any entity with access to a report for purposes of creation, modification, and testing. Testing resources may include the ability to deny or approve modified objects (e.g., production reports) and approve the modified objects while maintaining source control and document recovery. Some disclosed embodiments include an object tracking information system that integrates with Crystal Enterprise 8.0 through Business Objects Enterprise XI R2, including future revisions of these products. In addition, some disclosed embodiments might utilize a security model that is the same as or compatible with the security model of software offered under the trademark Business Objects.

Some software platforms, for example products offered under the trademark Business Objects, may have a system for transporting automated reports from development (i.e., from developers) to test (i.e., to quality control or quality assurance). Such systems may require a system administrator to update and change the automated reports by manually opening the object with a development tool. In some cases, before transport of an automated report can occur between departments, a system administrator may need to set the data source location, change environment-specific information, set up the report in the destination system, specify default parameter values, change database password information, include scheduling information, enter security information, perform formatting, and the like. Software change management systems may require a system administrator to use a software development tool to perform such functions. Requiring a system administrator, for example a quality-control person or release manager, to have a specialized program for transporting an automated report between departments (e.g., development or production) may be unnecessarily burdensome. Further, requiring manual changes to source documents using such specialized programs may be unnecessarily burdensome.

Disclosed embodiments are intended to allow automated version control while limiting unnecessary manual manipulation by system administrators. Some embodiments are intended to assist with the modification of automated reports within an enterprise and are intended to operate with or as an add-on to software products offered under the trademark Business Objects. Embodiments allow for streamlining and automation during the software development lifecycle by reducing system administrator intervention and responsibilities. Some embodiments are intended to interface with or act as an add-on for software products offered under the trademarks Crystal Enterprise and Business Objects Enterprise, to assist with migrating objects (e.g., automated reports) through the software development lifecycle in an automated, hands-off approach. Such systems may promote cost savings by reducing the headcount of system administrators. Further, such automated systems may reduce human errors associated with system administrators and promote consistency to create a more efficient workflow.

Some embodiments include functionality for monitoring the check-out and check-in of objects (e.g., automated reports). Check-in of an object may create a new link to a stored versioning chain. Migrations (i.e., transport) of an object to a test system may cause a copy of the object to be created. In some embodiments, an intermediate version of an object is created upon migration. Intermediate versions may include minor versions and major versions. Embodiments may use a variety of version numbering schemes to keep track of major and minor versions of objects. As an illustrative example, the following scheme may be used: “major.minor.revision” (e.g., 1.2.A) to keep track of the first revision (i.e., the “A” revision) of a second minor version of a first major version. Disclosed embodiments that store versions of objects during development and modification may be utilized as a form of back-up system. For example, in the event of a disaster in which production versions of objects are lost or otherwise compromised, embodied systems that store back-up copies (including versions) of objects may be utilized to restore the production versions.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, data processing system 107-1 refers to an instance of a data processing system, which may be referred to collectively as data processing systems 107, and any one of which may be referred to generically as a data processing system 107.

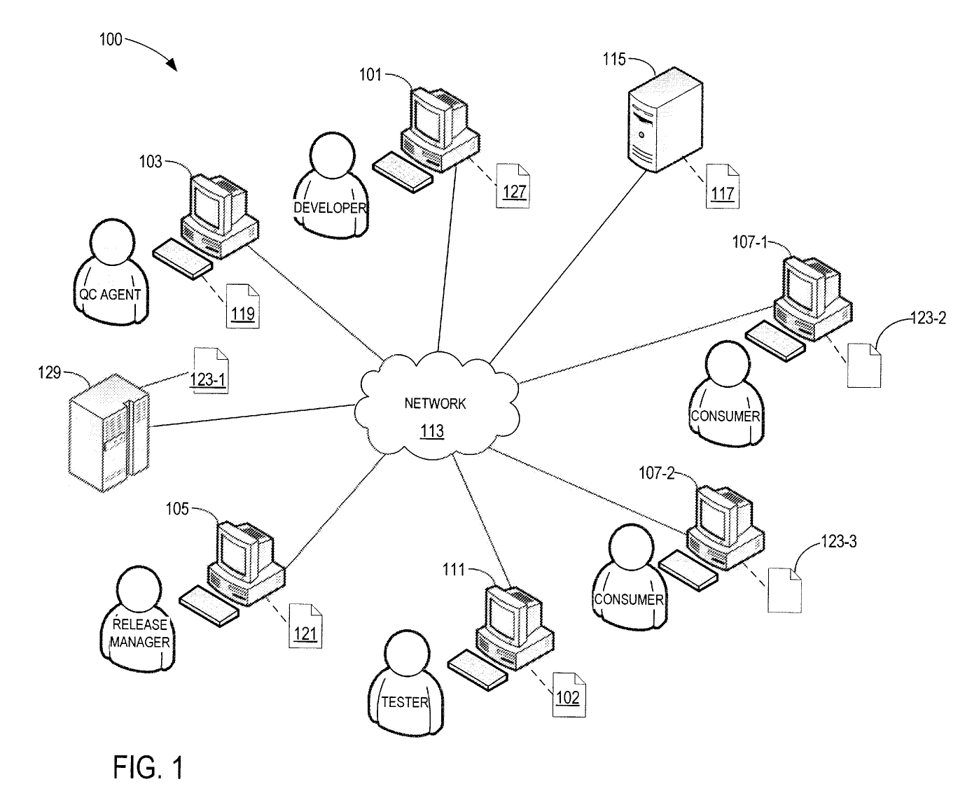

FIG. 1 illustrates an enterprise environment 100 in which disclosed embodiments may operate. Software change management server 115 may have access to, or may have embedded within its internal hardware, a computer program with instructions operable to achieve software change management of objects (e.g., automated reports) as disclosed herein. As shown, enterprise environment 100 includes production object server 129 that may be used as a server of objects such as automated report 123-1. Automated report 123-1 may be any object, including for example objects used for tracking payroll, accounts receivable, accounts payable, expenditures, and the like. As shown, users (i.e., consumers) of data processing system 107-1 and data processing system 107-2 have access to automated report 123-2 and automated report 123-3, respectively. Automated report 123-2 may be a version or copy of automated report 123-1. In some cases, the user of data processing system 107-1 and the user of data processing system 107-2 may simultaneously have access to and make edits to automated report 123-1. In such cases, automated report 123-3 and automated report 123-2 may be merged into document 123-1 following any edits or updating of records contained within an original automated report 123-1.

As shown, software change management server 115 communicates with object server 129 through a network 113. In some embodiments, network 113 is a private network; however, network 113 may include the Internet, and one or more wide area networks (WANs) or local area networks (LANs), for example. In operation, software change management server 115 may receive a request for revision for a production report. A focal point of disclosed embodiments is management of any modifications needed to objects such as automated report 123-1, which may be hosted by object server 129. For example, if the user of data processing system 107-1 finds a defect in automated report 123-2 or automated report 123-1, the user may request that the automated report undergo modifications. Accordingly, disclosed embodiments may be used to manage the lifecycle of such modifications and to coordinate the actions and work product of other elements shown in enterprise environment 100.

Upon receipt of a request for revision of an automated report such as automated report 123-1, software change management server 115 makes a copy of the report, shown as automated production report 117. During modification of automated report 123-1, users of data processing systems 107-1 and 107-2 may continue to use an unmodified, original version of automated report 123-1. In addition, software change management server 115 may make an additional back-up copy (not shown) that may be used in the event modifications to automated production report 117 must be restarted. In some embodiments, after making any necessary back-up copies of automated report 123-1 and automated production report 117, software change management server 115 provides substantially exclusive access to automated production report 117 to developer 101. In FIG. 1, developer 101 is shown as a data processing system (e.g., computer) that has access to modified production report 127, which may be an original copy of automated production report 117 or one of many saved, modified versions of automated production report 117. In operation of some embodiments, developer 101 may be a software-based development tool that is automated or used by a programmer. Developer 101 may have a user account associated with it, and the user account may have exclusive or substantially exclusive access to modified production report 127. Providing developer 101 with exclusive or substantially exclusive access to modified production report 127 prevents others from accessing or changing the report during modifications. The term “substantially exclusive” as used herein to describe access to modified production report 127, for example, is intended to represent that others may not easily gain access to modified production report 127 for purposes of modifying it. The term is not meant to exclude network administrators, network apparatuses, back-up apparatuses, development managers, and the like from accessing electronic files that are being modified. However, some embodiments may allow security measures to be implemented, using passwords or biometric data for example, to provide a user of developer 101 with exclusive access to modified production report 127.

The creation, adaptation, and editing of modified production report 127 may require several iterations or revisions. To support this, software change management server 115 may save multiple versions of modified production report 127 that are substantially exclusively available to developer 101. Alternatively, the multiple versions of modified production report 127 may be made available to quality control agent 103 or release manager 105. In some embodiments, software change management server 115 saves major and minor versions of modified production report 127. A major version may be saved upon completion of a draft for transport (i.e., submission) to quality control agent 103. In some embodiments, software change management server 115 insert links into modified production report 127 to track the various major versions and minor versions of the modified production report. In addition, software change management server 115 may provide a notes field for developer 101 to document the types of changes made to each version. Such revision notes may be embedded into modified production report 127 and persist in future versions of the report that may end up released to production, to provide a complete history of an automated report. In some embodiments, an automated report may associate permission levels with a user such as a programmer associated with developer 101, as shown. Using such permission levels associated with an automated report, software change management server 115 may grant developer 101 access to the revision history of an automated report but deny a consumer using data processing system 107-1 with access to the revision history.

As shown, following adaptation of the modified production report 127 by developer 101, software change management server 115 stores the report. In some embodiments, a major version of the modified production report 127 is stored preceding transport to quality control agent 103. In addition to storing modified production report 127, a back-up copy may be stored, possibly in a physical location different from that of software change management server 115.

Following modification of an automated report by a developer into a modified production report, the modified production report may be submitted or transported to quality control agent 103, which may be an automated software program, a person, or a person using a software program, as examples. Submitting or transporting the modified production report may not necessarily involve moving an automated report to a new location such as a hard-drive within quality control agent 103. Instead, quality control agent 103 may be given access to a version or copy of a modified production report 127 that may be stored on software change management server 115. Alternatively, the modified production report may be “transported” to quality control agent 103 granting access to quality control agent 103 to go to an Internet or intranet website (not depicted) that hosts the modified production report 127. As shown, quality control agent 103 has access to a copy, shown as report 119, of modified production report 127. By quality control agent 103 operating on or reviewing a report 119, which is a copy of modified report 127, any problems associated with quality control agent 103's work may be corrected by reverting to modified production report 127.

In some embodiments, in combination with transporting the modified production report to quality control agent 103, the software change management server 115 may provide substantially exclusive access to modified production report 127 to quality control agent 103 by excluding others (e.g., developer 101) from accessing it. Transporting the modified production report to quality control agent 103 allows for a determination of whether the modified production report is a quality-compliant production report. The quality control agent 103 may determine this using a set of predetermined values or by testing the modified production report 127 with test data. As shown, test agent 111 may be provided with a copy of the modified production report 127, shown as test production report 102. Testing may occur simultaneously with the review by quality control agent 103 or release manager 105. Alternatively, test agent 111 may test an automated report at any stage of development, including after it has been released to production. In some embodiments, software change management server 115 provides access to all automated reports to test agent 111, by providing test agent 111 with a copy of a requested automated report.

If, during testing by the test agent 111 or quality-control agent 103 of report 119, a determination is made that modified production report 127 is a quality-compliant production report, software change management server 115 may then provide substantially exclusive access to the quality-compliant production report to release manager 105 for determining whether the quality-compliant production report is a releasable production report. Release manager 105 an automated software program, a person, or a person using a software program, as examples. Software change management server 115 may provide access to the quality-compliant production report by copying an approved version of report 119 to report 121. Accordingly, report 121 may include any version logs or notes made by quality control agent 103. In addition, software change management server 115 may automatically track actions taken by quality control agent 103 and developer 101 for providing a log to release manager 105. In some embodiments, release manager 105 has a relatively high permission level regarding viewing version logs, with an ability to view logs created by all users, developers, and quality control agents. In some embodiments, quality control agent 103 is able to view version logs created by developer 101, but not version logs created by release manager 105. In such a way, embodied systems may include a software change management server 115 that grants limited access to version logs based on a permission level associated with a member of enterprise environment 100.

In determining whether the quality-compliant production report (of which report 121 is a copy) is releasable, release manager 105 may compare the quality-compliant production report to a set of predetermined parameters. In addition, release manager 105 may review any version logs created by developer 101, quality control agent 103, or software change management server 115, as examples. Release manager 105 may also request analysis by test agent 111 of report 121 or a copy of report 121. If release manager 105 deems the quality-compliant production report (by analyzing report 121) is a releasable production report, the report 121 or a copy of report 121 may be transported to production. Accordingly, software change management server 115 substitutes a releasable version of report 121 for production report 123-1. In some embodiments, the replaced version of production report 123-1 is archived. In addition, upon release of report 121, software change management server 115 may create back-up copies for use in the event of corruption or other failures.

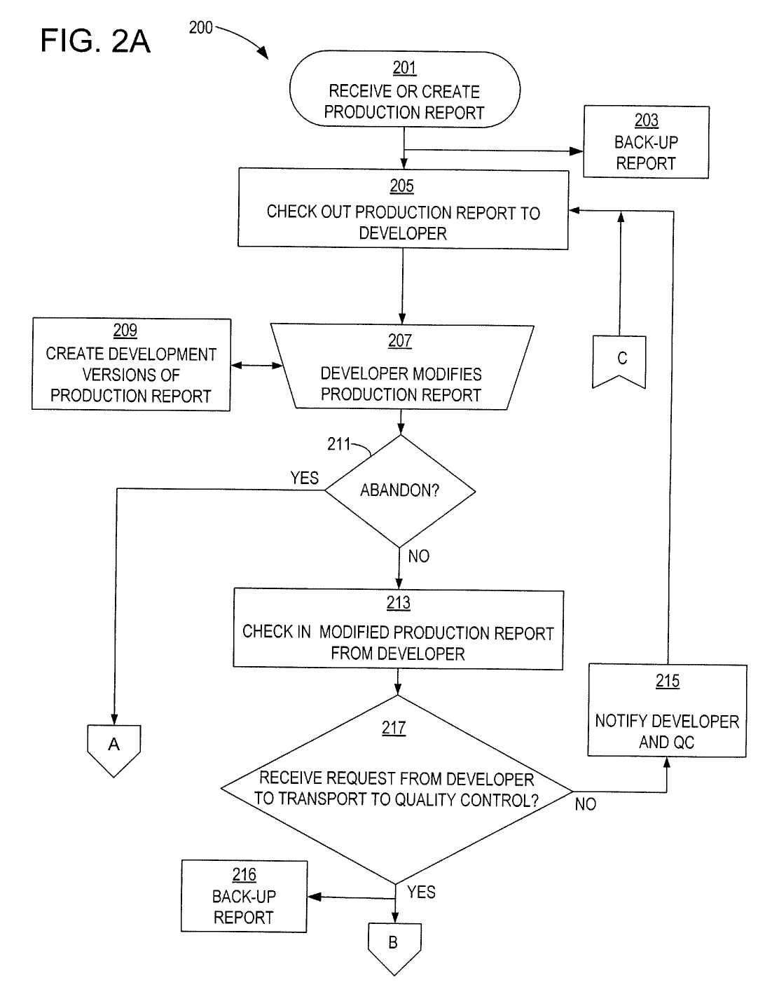

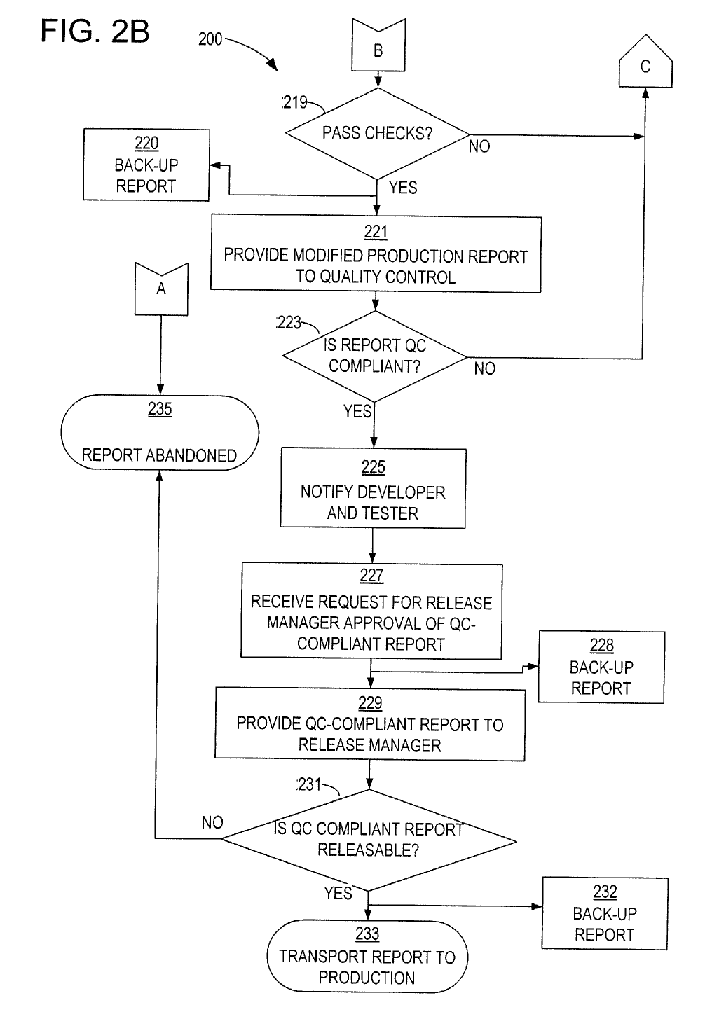

FIG. 2 illustrates methodology 200 with representative operations for managing automated report versions. For clarity, FIG. 2 is distributed across two pages depicted as FIGS. 2A and 2B. The enterprise environment 100 illustrated in FIG. 1 may be used to perform methodology 200. Further, methodology 200 may be performed by a computer program stored on computer readable medium with instructions operable to cause one or more data processing systems to carry out the operations shown in methodology 200.

As show, operation 201 relates to receiving or creating a production report for modification. In some cases, a user or consumer of a production report may identify a problem with the production report that necessitates modifying the production report. Operation 201 may include creating a production report from a template or from another production report. In some instances, a production report may be duplicated and revised to prevent having to start anew each time a production report is created. In some embodiments, the production report created in operation 201 is a software-based, automated report that may be used in organizing, creating, and providing data regarding payroll, accounts receivable, accounts payable, expenditures, past due accounts, and investments, as examples. To accomplish operation 201, software change management server 115 (FIG. 1) may receive a request to modify an automated report or a request to create a new automated report. As shown, operation 203 relates to backing up a report. Operation 203 may be accomplished by a server (e.g., software change management server 115 from FIG. 1) storing a production report (e.g., production report 123-1 from FIG. 1) and backing it up as a starting point in the event modifications go badly.

As shown, operation 205 includes checking out the production report to a developer. This operation may include granting a developer substantially exclusive access to the production report for a predetermined amount of time. In some embodiments, a production report to be modified may be backed up and copied to a working directory accessible only to a developer, or in instances when the developer is an individual, the developer's managers, for example. Such security measures prevent others from accidentally or maliciously altering the production report that is undergoing modifications. A developer may also, as part of operation 205, copy a production report for making off-line edits. Later, during check-in, an automated system such as software change management server 115 (FIG. 1) may allow for checking the report in and accounting for all changes made since check out.

As shown, during operation 207 a developer modifies the production report. In some embodiments, a developer creates development versions in operation 209. Development versions may consist of major or minor revisions and may be stored by a centralized system such as software change management server 115 (FIG. 1). In optional operation 211, in some embodiments a determination is made whether modifying the production report should proceed or whether the production report should be abandoned. If the report should be abandoned, then in operation 235, the report is abandoned, such as by software change management server 115 (FIG. 1) denying access to the production report or the version of the production report that is to be abandoned. If the production report should not be abandoned, as shown in operation 213 the modified production report is checked in from the developer. Check-in may consist of the developer providing a pointer to a document on a hard-drive local to the developer, by importing the modified production report into a centralized system such as software change management server 115 (FIG. 1), or by another method of the developer indicating that modifications to the production report are ready to be reviewed and approved.

In operation 217, a determination is made whether a developer has requested transport to quality control. If no request has been detected, in operation 215 the developer is notified. In addition, as shown in operation 215, quality control may be notified. Operation 215 may occur periodically or because of a predetermined occurrence to keep the developer informed regarding outside occurrences that may affect or depend on modification of a production report. If a request is not received from a developer to transport the production report to quality control, the production report remains checked out to or is re-checked out to the developer as provided in operation 205. If a request is received from the developer in operation 217 to transport the modified production report to quality control, in operation 216 the modified production report is backed up and in optional operation 219 one or more checks are performed to determine whether the modified production report should be forwarded to quality control. For example, in operation 219 the naming convention of an electronic file associated with the modified production report may be checked against a predetermined set of rules. In addition, other checks regarding correct operability of the modified production report may be manually run by a human tester or automatically run by a software program. If the modified production report does not pass initial checks, as shown the modified report is returned to the developer or re-checked out to the developer for further modification. If the modified production report passes the initial checks in operation 219, in operation 220 a back-up report is made and in operation 221, the modified production report is provided to quality control. If in operation 223 quality control personnel or software determines the modified production report to be a quality-compliant production report, in optional operation 225 notification is sent to the developer and the tester that quality control has approved the modified production report. If the modified production report is not a quality-compliant production report, the modified production report either may be abandoned or checked-out again to a developer for further edits.

As shown, optional operation 227 includes receiving a request for release manager approval of a quality-compliant production report. A request may come from a tester, a developer, or a quality control agent, as examples. As shown, operation 228 relates to backing up the quality-compliant report prior to providing the quality-compliant production report to a release manager (operation 229). In operation 231, a determination is made whether a quality-compliant production report is releasable. For example, an automated release manager, a human release manager, or a human release manager using a software based system may compare the quality-compliant production report to determine whether it is ready for release. In addition, a release manager may review one or more version logs associated or embedded into the quality-compliant report to gauge the report's compliance with predetermined parameters, for example. Determining whether a report is releasable, as shown in operation 231, may include a tester performing tests of a quality-compliant production report. If the quality-compliant production report is deemed releasable, as shown, methodology 200 progresses to operation 233, which relates to transporting the releasable report to production. Prior to or in conjunction with transporting the releasable report to production, operation 232 involves making a backup of the releasable report. Transporting the releasable report to production, in some embodiments, includes notifying users or consumers of a production report that there may be an interruption of service with the production report, backing up an old version of the production report, backing up a new version of a production report (i.e., the releasable report), and replacing the old version of the production report with the new, modified, quality-compliant, tested, releasable, replacement production report.

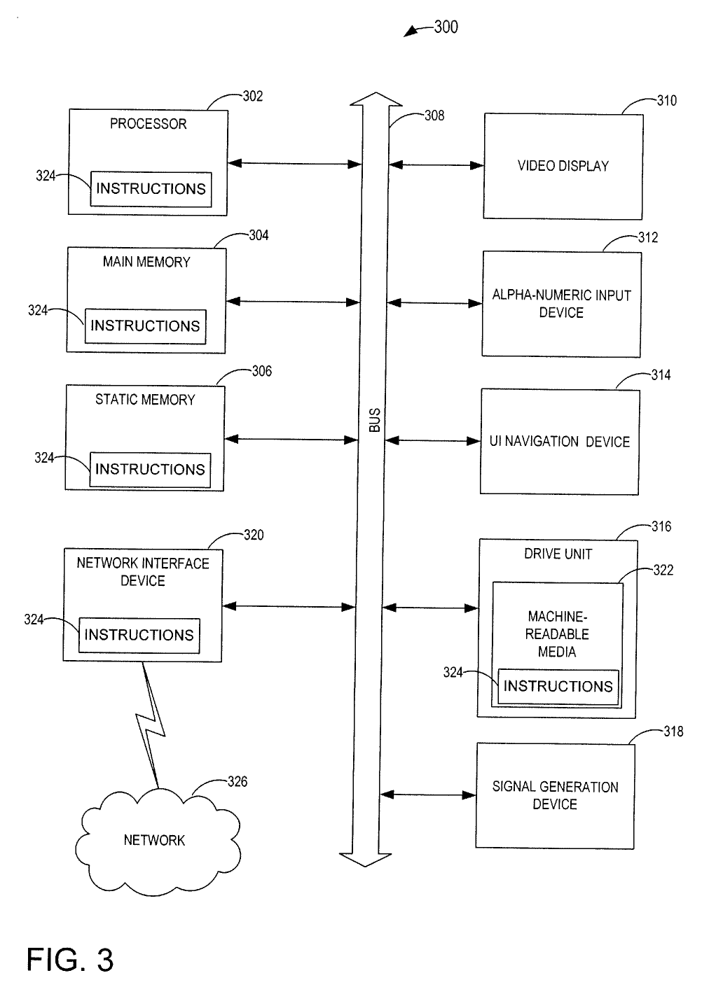

FIG. 3 illustrates in block diagram form a data processing system 300 within which a set of instructions may operate to perform one or more of the methodologies discussed herein. Data processing system 300 may operate as a standalone device or may be connected (e.g., networked) to other data processing systems. In a networked deployment, data processing system 300 may operate in the capacity of a server or a client data processing system in a server-client network environment, or as a peer computer in a peer-to-peer (or distributed) network environment. Example data processing systems include, but are not limited to a digital video recorder, a personal computer (PC), a tablet PC, set-top box, a cable box, a satellite box, an electronic programming guide box, a personal data assistant, a cellular telephone, a smart phone, a web appliance, a network router, a switch, a bridge, a server, or any machine capable of executing a set of instructions (sequential or otherwise) that specify actions to be taken by that machine. Further, while only a single data processing system is illustrated, the term “data processing system” shall also be taken to include any collection of data processing systems that individually or jointly execute a set (or multiple sets) of instructions to perform any one or more of the methodologies discussed herein.

As shown, data processing system 300 includes a processor 302 (e.g., a central processing unit, a graphics processing unit, or both), a main memory 304, and a static memory 306 that may communicate with each other via a bus 308. In some embodiments, the main memory 304 and/or the static memory 306 may be used to store the indicators or values that relate to multimedia content accessed or requested by a consumer. Data processing system 300 may further include a video display unit 310 (e.g., a television, an liquid crystal display or a cathode ray tube) on which to display multimedia content such as pay-per-view sporting events, television programs, video-on-demand movies, and the like. Data processing system 300 also includes an alphanumeric input device 312 (e.g., a keyboard or a remote control), a user interface (UI) navigation device 314 (e.g., a remote control or a mouse), a disk drive unit 316, a signal generation device 318 (e.g., a speaker) and a network interface device 320. The input device 312 and/or the UI navigation device 314 (e.g., the remote control) may include a processor (not shown), and a memory (not shown). The disk drive unit 316 includes a machine-readable medium 322 that may have stored thereon one or more sets of instructions and data structures (e.g., instructions 324) embodying or utilized by any one or more of the methodologies or functions described herein. The instructions 324 may also reside, completely or at least partially, within the main memory 304, within static memory 306, within network interface device 320, and/or within the processor 302 during execution thereof by the data processing system 300.

The instructions 324 may further be transmitted or received over a network 326 (e.g., a content provider) via the network interface device 320 utilizing any one of a number of transfer protocols (e.g., broadcast transmissions, HTTP). While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine (i.e., data processing system) and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the disclosed systems may be described in connection with one or more embodiments, it is not intended to limit the subject matter of the claims to the particular forms set forth. On the contrary, it is intended to cover such alternatives, modifications and equivalents as may be included within the spirit and scope of the subject matter as defined by the appended claims.

What is claimed is:

1. A method of managing object versions, the method comprising:
receiving an object related to a request for revision;
checking out the object to a developer for adaptation to a modified object;
checking in the modified object following adaptation by the developer; and
transporting the modified object to a quality control agent for determining whether the modified object is a quality-compliant object, wherein:
if the modified object is a quality-compliant object, transporting the quality-compliant object to a release manager for determining whether the quality-compliant object is a releasable object, wherein:
if the quality-compliant object is a releasable object, transporting the releasable object to production.

2. The method of claim 1, wherein:
if the modified object is not a quality-compliant object, determining whether the modified object should undergo further modification, wherein:
if the modified object should undergo further modification, checking out the modified object to the developer for further processing.

3. The method of claim 2, wherein:
if the modified object should not undergo further modification, abandoning the modified object.

4. The method of claim 1 further comprising:
determining whether a transport request is received to transport the modified object to quality control, wherein:
if the request transport request is received, checking the modified object for compliance with predetermined parameters.

5. The method of claim 4, wherein the transport request is initiated by the developer.

6. The method of claim 4, wherein if the transport request is not received, notifying the developer that the transport request has not been received.

7. The method of claim 6 further comprising:
notifying a tester associated with the developer that the transport request has not been received.

8. The method of claim 1, wherein transporting the modified object to a quality control agent includes making a back-up copy of the modified object.

9. The method of claim 1 wherein checking out the object to a developer includes:
making a backup the object; and
providing the developer with a copy of the object.

10. The method of claim 1 further comprising:
saving a plurality of versions of the object during adaptation by the developer.

11. The method of claim 1, wherein checking in the modified object includes backing up the modified object.

12. The method of claim 1, wherein receiving an object related to a request for revision includes creating the object from a template.

13. The method of claim 1, wherein if the compliant object is not a releasable object, the method further includes:
determining whether the releasable object should be abandoned, and wherein:
if the releasable object should not be abandoned, submitting the releasable object for further modification.

14. The method of claim 13, wherein if the releasable object should be abandoned, the method further includes:
abandoning the releasable object.

15. The method of claim 1 further comprising:
upon receiving the object related to the request for revision, making a backup copy of the object.

16. A computer program stored on a computer readable medium having instructions operable for:
storing a production report related to a request for revision;
providing substantially exclusive access to the production report to a developer for adaptation into a modified production report;
storing the modified production report following adaptation by the developer; and
providing substantially exclusive access to the modified production report to a quality control agent for a determination of whether the modified production report is a quality-compliant production report, wherein:
if the modified production report is a quality-compliant production report, providing substantially exclusive access to the quality-compliant production report to a release manager for determining whether the quality-compliant production report is a releasable production report, and wherein:
if the quality compliant production report is a releasable production report, substituting the production report with the releasable production report.

17. The computer program of claim 16, further including instructions operable for:
if the modified production report is not a quality-compliant production report, determining whether the modified production report requires further modification, and wherein:
if the modified production report requires further modification, providing to the developer substantially exclusive access to the modified production report for further processing.

18. The computer program of claim 17, further including instructions operable for:
if the modified production report does not require further modification, abandoning the modified production report by restricting access to the modified production report.

19. The computer program of claim 16, further including instructions operable for:
determining whether a transport request is received to transport the modified production report to quality control, and wherein:
if the transport request is received:
checking the modified production report for compliance with predetermined parameters.

20. The computer program of claim 19, wherein if the transport request is not received, instructions are further operable for:
notifying the developer that the transport request has not been received.

21. The computer program of claim 20, further including instructions operable for:
notifying a tester associated with the developer that the transport request has not been received.

22. The computer program of claim 16, further including instructions operable for:
saving a plurality of versions of the production report during adaptation by the developer.

23. The computer program of claim 16, further including instructions operable for:
if the quality-compliant production report is not a releasable production report, determining whether quality-compliant production report should be abandoned, and wherein:
if the releasable production report should not be abandoned, providing the developer with substantially exclusive access to the quality-compliant production report for further modification.

24. A software change management server comprising a machine-readable medium having instructions operable for:
copying an automated report, wherein the copied automated report is for modification by a developer;
checking out the automated report to the developer;
storing one or more minor versions of the automated report;
checking in a revised version of the automated report in response to a check-in request by the developer;
creating a major version of the automated report based on the revised version;
in response to a transport request by the developer:
copying the major version of the automated report as a modified automated report; and
transporting the modified automated report to a quality control agent to result in the quality control agent having substantially exclusive access to the modified automated report for determining whether the modified automated report is a quality-compliant report;
in response to the quality control agent indicating the modified automated report is a quality-compliant report:
copying the modified automated report as a quality-compliant automated report; and
transporting the quality-compliant automated report to a release manager to result in the release manager having substantially exclusive access to the quality-compliant automated report for determining whether the quality compliant report is a releasable automated report; and
in response to the release manager indicating the quality-compliant report is a releasable automated report:
backing up a copy of the automated report; and
replacing the automated report with the releasable report.
